(19) United States
(12) Patent Application Publication
(10) Pub. No.: US 2007/0157850 A1
(43) Pub. Date: Jul. 12, 2007

(54) METHOD FOR ACHROMATIZING DYE, DEVICE WHICH USES THE SAME, AND METHOD FOR RECYCLING RECORDING MEDIUM

(75) Inventors: Yuichi Hashimoto, Tokyo (JP); Tatsunori Ishiyama, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/685,385

(22) Filed: Mar. 13, 2007

Related U.S. Application Data
(63) Continuation of application No. PCT/JP06/20034, filed on Sep. 29, 2006.

(30) Foreign Application Priority Data
Sep. 30, 2005 (JP) 2005-289107

(51) Int. Cl. C09D 11/00

(52) U.S. Cl. 106/31.58

(57) ABSTRACT

The present invention provides a method for easily and quickly erasing images, including letters, formed on a printed matter at a low cost, and a device for utilizing the method. The images, including letters, on the printed matter are erased by bringing an oxidative gas generated by a remote plasma device into contact with a portion of the image, colored with a dye.

This application is a continuation of International Application No. PCT/JP2006/320034, filed on Sep. 29, 2006, which claims the benefit of Japanese Patent Application No. 2005-289107 filed on Sep. 30, 2005.

### BACKGROUND OF THE INVENTION

1. Field of the Invention

The present invention relates to a method for achromatizing a dye on a printed matter to erase images, including letters, formed on the printed matter, and a device which uses the method.

2. Description of the Related Art

Printing images on paper has been increasingly demanded as computers, printers, copiers and facsimiles are spreading. Demands for paper have been still increasing even now witnessing rapid development of computerization and paperless systems, because no medium which exceeds paper in visibility and portability has been developed so far.

On the other hand, technological developments for recycling/reutilizing paper are still gaining importance to effectively utilize limited resources. The conventional paper recycling process involves redeflocculation of recovered paper with water, removal of ink by floatation in a deinking step, and bleaching. This method, however, involves problems of reduced paper strength and higher cost than that for producing new paper. Therefore, there are demands for paper reutilization or recycling methods which need no redeflocculation or deinking step.

Under these situations, studies have been made recently on printing paper with an image-forming material containing an erasable dye composition whose chromatic compound can be changed from color-developed state to color-erased state. As such image-forming materials, Japanese Patent Application Laid-Open No. S63-039377 reports a material which utilizes a reversible transparency change of a recorded layer caused by controlling thermal energy to be applied. Japanese Patent Application Laid-Open No. 2001-105741 reports a material which utilizes intermolecular interactions between an electron-donating color fixing agent and electron-accepting color developing agent. Japanese Patent Application Laid-Open No. H11-116864 discloses an ink containing a dye which loses its color when irradiated with electron beams, and Japanese Patent Application Laid-Open No. 2001-049157 discloses an ink containing an additive which can function to erase color of a colorant when it is irradiated with light. Moreover, the International Publication No. WO02/088265 pamphlet reports an ink jet ink erasable when irradiated with light by use of monascus dyes and a recording method using the ink. Japanese Patent Application Laid-Open No. H07-253736 proposes a method which breaks and erases images recorded on ordinary paper in the presence of an activated gas.

### SUMMARY OF THE INVENTION

However, the methods disclosed by Japanese Patent Application Laid-Open Nos. S63-039377 and 2001-105741 are not practical, because of high initial and running costs of recording media and writing/erasing devices which they use. The method disclosed by Japanese Patent Application Laid-Open No. H11-116864, which involves electron beam irradiation, may deteriorate a medium base and generate a secondary X-ray, although to a limited extent. The ink disclosed by Japanese Patent Application Laid-Open No. 2001-049157 is incorporated with an additive, which is specifically a dye-based sensitizer, in a high 1/10 to 10/10 ratio by weight to a colorant to increase the ink cost. The methods disclosed by the International Publication WO2002/088265 pamphlet and Japanese Patent Application Laid-Open No. H07-253736 are required to erase images more easily and quickly.

It is an object of the present invention to easily and quickly achromatize images, including letters, formed on a recording medium represented by paper, more specifically to provide a method and a device therefor which can quickly achromatize a colored portion in which a colorant component (dye) of an ink is attached to or fixed on a printed matter, to allow for recycling the recording media at a low cost for resource reutilization. It is another object to provide a method and a device therefor which can achromatize a dye for recycling recording media on which images are formed with the dye without causing deterioration of their mechanical strength.

The inventors of the present invention have extensively studied to achieve the above objects by focusing on remote plasma discharging techniques carried out at the atmospheric pressure, which have been employed to treat exhaust gases or remove/decompose organic contaminants. The conventional plasma treatment exposes a solid surface to a plasma in a plasma area (plasma space) or an area which is substantially in contact with the plasma area. As a result, it produces ozone at a very high concentration, several hundreds ppm or more. Therefore, it fails to efficiently achromatize a dye, one reason therefor being a high load required to treat ozone.

The inventors of the present invention have found that a colored portion on a printed matter can be efficiently achromatized by exposing the portion to an oxidative gas generated by a remote plasma device, to oxidize the dye molecules which constitute the colored portion and adequately accelerate cleavage of the chemical bonds in the molecules. They have also found that achromatization of colored portion on printed matter can be achieved by use of a remote plasma device while controlling adverse effects on environments, that it can be achieved more easily and quickly at a reduced cost by use of creeping, coplanar or dielectric barrier discharge as a plasma source, and that it can be achieved more efficiently when a porous inorganic pigment is present on a recording medium. It is also found that ionization potential of a dye in ink can be kept lower than that of the solid state when the ink is applied to a recording medium coated with a porous inorganic pigment of specific properties, and that the above effect can be remarkably enhanced when dye powder has a specific ionization potential before being contained in an ink and exhibits a specific ionization potential relative to that of the solid dye after being applied to a recording medium. The present invention has been developed, based on these findings.

More specifically, one aspect of the present invention is a method for achromatizing a dye on a printed matter, comprising exposing the dye to an oxidative gas generated by a remote plasma device.

Another aspect of the present invention is a device for achromatizing a dye on a printed matter, comprising a remote plasma device which produces an oxidative gas by using any discharging means of corona discharge, creeping discharge and dielectric barrier discharge, and supporting means for positioning the printed matter in such a way that the dye thereon is exposed to the oxidative gas.

Still another aspect of the present invention is a method for recycling recording media, comprising a step for achromatizing a colored portion on a printed matter by the above achromatizing method.

The method for achromatizing a colored portion on a printed matter and the device therefor, both of the present invention, can easily and quickly erase images on a recording medium represented by paper. Moreover, they can quickly and easily achromatize a colored portion while controlling deterioration of mechanical strength of the recording medium for the printed matter, and allow for recycling of the recording medium at a reduced cost. The present invention can reutilize used recording media as resources.

Further features of the present invention will become apparent from the following description of exemplary embodiments with reference to the attached drawings.

### BRIEF DESCRIPTION OF THE DRAWINGS

FIG. 1 is a side view schematically illustrating one embodiment of the achromatization device of the present invention.

FIG. 2A is a side view schematically illustrating another embodiment of the achromatization device of the present invention.

FIG. 2B is a side view schematically illustrating a remote plasma device for the device shown in FIG. 2A.

FIG. 3 is a side view schematically illustrating still another embodiment of the achromatization device of the present invention.

FIG. 4 is a side view schematically illustrating still another embodiment of the achromatization device of the present invention.

FIG. 5 schematically illustrates one embodiment of power source for the achromatization device of the present invention.

FIG. 6 schematically illustrates one embodiment of an aerial gap for the achromatization device of the present invention.

FIG. 7 schematically illustrates one embodiment of an aerial gap for the achromatization device of the present invention.

### DESCRIPTION OF THE EMBODIMENTS

The method of the present invention for achromatizing a dye on a printed matter comprises at least one step of exposing the dye which constitutes a colored portion on the printed matter to an oxidative gas generated by a remote plasma device.

The term “achromatization” used in this specification means to reduce optical density of images, including letters, on a printed matter to a sufficient level to allow the recording medium to be recyclable. It includes not only a case where a portion colored with an ink on a recording medium is completely invisible (“erased” in this case) but also a case where the portion loses optical density by 80% or less of the initial level (“reduced color” in this case). In terms of residual optical density rate, the “reduced color” means that a colored portion has an optical reflectivity of 20% or less of the initial level at the maximum absorption wavelength.

<Recording Medium>

The recording media to which the achromatization method of the present invention is applicable are not limited so long as they can be printed with an erasable ink. They include paper, films, photographic paper, seals, labels, compact disks, IC cards, various tugs, metals, glass, various plastic products, slips, e.g., those for home delivery systems, and a combination thereof. Paper may be acidic, neutral or alkaline so long as it is recyclable. The paper may be produced by a common paper-making method which mainly uses chemical pulp (represented by LBKP or NBKP) and a filler, and may use an internal sizing agent or paper-making aid, as required. The pulp material to be used may be a material which uses a combination of mechanical pulp and recycled pulp, or a material mainly composed thereof. The fillers include calcium carbonate, kaolin, talc and titanium dioxide. The paper thus produced may be incorporated with, or coated with, a hydrophilic binder, matting agent, film curing agent, surfactant, or polymer latex or dye mordant. The paper preferably weighs in a range from 40 to 700 g/m².

The recording media to which the achromatization method of the present invention is applied preferably have a porous inorganic pigment on the surface, and are preferably coated with a layer containing an inorganic pigment. The porous inorganic pigment may have a spherical or irregular shape. It preferably has a pore volume of 0.2 cc/g or more and 2.0 cc/g or less, and dispersed particle diameter of 0.01 μm or more and 0.5 μm or less. It preferably satisfies these two conditions simultaneously. When an ink containing the porous inorganic pigment having a pore volume and/or dispersed particle diameter in the above range is fixed on a recording medium, the dye exhibits an ionization potential lower than that of the solid state by 0.1 eV or more. As a result, it can realize an excellent ink achromatization effect. The pore volume of the porous inorganic pigment may be determined by a mercury porosimeter which penetrates mercury into the sample. The pore volume of the porous inorganic pigment alone can be determined from a pore volume distribution against a pore diameter, measured by the mercury penetration, because a recording medium and an inorganic pigment generally have a different pore diameter. The dispersed particle diameter may be determined by scanning electron microscopy.

The porous inorganic pigments include alumina, silica, silica-alumina, colloidal silica, zeolite, clay, kaolin, talc, calcium carbonate, barium sulfate, aluminum hydroxide, titanium dioxide, zinc oxide, satin white, diatomaceous earth, acid clay, and a composite of alumina or silica.

A recording medium with a porous inorganic pigment may be produced by coating a recording medium of paper (base paper) with an aqueous coating solution prepared by incorporating the porous inorganic pigment with an aqueous binder. The aqueous binders useful for the present invention include, but not limited to, the following water-soluble high-molecular-weight compounds, e.g., polyvinyl alcohol, casein, styrene/butadiene rubber, starch, polyacrylamide, polyvinyl pyrrolidone, polyvinyl methyl ether and polyethylene oxide.

The porous inorganic pigment/aqueous binder mass ratio is in a range from 0.1 to 100, preferably 1 to 20. When the mass ratio is 100 or less, exfoliation of the porous inorganic pigment from the recording medium, a so-called powder dropping can be prevented. When it is 0.1 or more, the excellent color reduction or erasion effect of ink jet images formed on the recording medium can be realized. The aqueous coating solution may be incorporated with a pigment dispersant, water retention agent, thickening agent, defoaming agent, releasing agent, colorant, water resistant agent, wetting agent, fluorescent dye or UV absorber, as required.

A recording medium may be coated with an aqueous coating solution by roll coating, blade coating, air-knife coating, gate roll coating, bar coating, spray coating, gravure coating, curtain coating or comma coating.

A recording medium is preferably coated with an aqueous coating solution to 0.1 to 50 g/m² as solids. At 0.1 g/m² or more, color reduction or erasion of ink jet images on the recording medium can be quickly performed. At 50 g/m² or less, on the other hand, wasteful aqueous coating solution consumption can be avoided.

A recording medium coated with an aqueous coating solution may be further coated with an aqueous solution containing nitrate, sulfate, formate or acetate of zinc, calcium, barium, magnesium or aluminum while the coating solution is still wet, prior to the subsequent step. This treatment will help solidify the aqueous binder in the solution. The recording medium having the surface treated can be produced by drying the recording medium coated with the aqueous coating solution by a hot wind drying furnace or heat drum. When the coating film of the aqueous coating solution on the recording medium is dried by a heat drum, a coated layer can be obtained by pressing the heated coating film to the drum before drying. After drying, a strong coating film without film exfoliation or powder dropping can be obtained by subjecting the recording medium to a calendar treatment.

<Ink>

The mechanisms of the achromatization for the present invention to reduce or erase color of a dye, which constitutes a colored portion on a printed matter conceivably, result from cleavage of the dye chemical bonds, accelerated when they are exposed to an oxidative gas. The dye achromatization can easily proceed when a solid dye has an ionization potential of 6.0 eV or less. Moreover, it is essential for a solid dye to have an ionization potential of 4.2 eV or more, in order to prevent oxidation and light-caused deterioration in air.

It is also necessary for a dye held on a recording medium to have an ionization potential lower than that of the solid state by 0.1 eV or more, specifically by 0.15 to 0.7 eV or less. A dye having the above ionization potential relationship after the ink is applied to a recording medium can be easily and quickly achromatized. It is also necessary that the porous inorganic pigment has a pore volume of 0.2 cc/g or more and 2.0 cc/g or less or a dispersed particle diameter of 0.01 μm or more and 0.5 μm or less, in order to keep the ionization potential of the dye in the ink applied to the recording medium in the above range.

The mechanisms are considered to take place by the following phenomena, although not fully substantiated.

It is known that the value of ionization potential of a dye is closely related to the agglomerated conditions of dye molecules (T. Ma, K. Inoue, H. Noma, K. Yao and E. Abe, Ionization potential studies of organic dye absorbed onto TiO₂ electrode, Journal of Materials Science Letters, 2002, vol. 21, p. 1013 to 1014). When a dye-containing ink is applied to a recording medium containing a porous inorganic pigment, on the other hand, the dye molecules are adsorbed on the surface pores of the porous inorganic pigment to control agglomeration of the dye molecules with each other. As a result, the dye tends to have an ionization potential lower than that of the solid state (agglomerated state). It is therefore essential to select a porous inorganic pigment having an adequate pore volume or dispersed particle diameter for dye molecules contained in an ink to reduce ionization potential of the dye in the ink applied to a recording medium.

Such a value of dye ionization potential can be determined by an aerial photoelectron spectrometer (e.g., AC-1, Riken Keiki) at a contact point between photoelectron emitting current and photon energy which follows Fowler's rule.

The ink for producing a printed matter to which the achromatization method of the present invention is applicable is not limited, so long as it contains an erasable dye which can be fixed on a recording medium. Images can be formed on a recording medium by any printing method which uses an ink jet printer, copier, printer or the like. It may be used for forming images by a utensil, represented by pen, but is preferably used for ink jet printing. Examples of the inks useful for the present invention include those containing a dye dissolved, dispersed or dissolved and dispersed in an organic solvent or water.

(Dye)

The erasable dye is not limited. For example, it may be natural or synthetic, or any dye which can develop color in the presence of a developing agent. However, it preferably has a polyene structure. Conjugated carotenoid polyenes, represented by annatto and gardenia yellow dyes, can be cited as dyes of polyene structure. The erasable dye may be natural or synthetic, the former being more preferable in consideration of the effects on human bodies. Microbial dyes produced by microorganisms and dyes extracted from animals or plants can be cited as examples of natural dyes. Microbial dyes are produced by an easier production management procedure, more stably and more massively than extracted ones.

Microbial dyes are produced from strains capable of producing the dyes by unlimited known culturing methods. They are generally extracted from a culture solution of the microorganisms. The culture solution may be directly incorporated in an ink after being concentrated without being treated for extraction or refining, so long as it can retain ink characteristics. Specific examples of these microbial dyes include monascus, violacein, melanin, carotenoid, chlorophyll, phycobilin, flavin, phenajine, prodigiosin, violacein, indigo, benzoquinone, naphthoquinone and anthraquinone dyes, and other known ones (Dye microbiology, P. Z. Margalith, Chapman & Hall, London, 1992). Of these dyes, those exhibiting excellent erasability with an acidic gas, described later, are monascus, anthraquinone, violacein and indigo ones, especially monascus dyes.

Monascus dyes are those produced by filamentous bacteria belonging to genus Monascus (monascus bacterium), and have been used as colorants for red wines and meats in China and Taiwan for long years. Therefore, their safety has been confirmed. Monascus dyes are generally compositions of compounds of similar structure with different substituents, e.g., monascorubrin for orange color; ankaflavin and monascin for yellow color; and monascorubramin for red color, rubropunctatin and rubropunctamine (J. Ferment., Technol., Vol. 51, p. 407, 1973). They are insoluble in water, but monascorubrin and rubropunctatin are known to make water-soluble red monascus dyes when treated with a water-soluble amino compound, e.g., water-soluble protein, peptide or amino acid in a culture solution to produce a water-soluble complex (Journal of Industrial Microbiology, Vol. 16, pp. 163 to 170, 1996).

The strain for producing a monascus dye is not limited so long as it is a filamentous bacterium belonging to genus Monascus. These filamentous bacteria include Monascus purpureus (catalog No. NBRC 4478, Incorporated Administrative Agency National Institute of Technology and Evaluation Biological Resource Center (NBRC)), Monascus pilosus (NBRC 4480) and Monascus ruber (NBRC 9203). Their variants and mutant strains are also included.

A strain for producing a monascus dye may be cultured in a solid or liquid medium, the former producing a monascus dye powder and the latter a liquid monascus dye or its extract with an organic solvent. The culture medium may be a known one containing a carbon source, nitrogen source, inorganic salt and trace quantities of nutrient(s). The carbon sources include saccharides, e.g., glucose or sucrose, acetic acid and hydrolyzed starch. The nitrogen sources and trace quantities of nutrients include peptone, yeast extract and malt extract. The inorganic salts include sulfates and phosphates.

More specifically, a monascus strain can be produced by culturing the bacterium inoculated in a medium, at 20 to 40° C. in an aerobic atmosphere for 2 to 14 days. The culture system needs no pH control when stirred by aeration. A dye, which contains monascorubrin and rubropunctatin at a high concentration, can be produced under an acidic condition, because of controlled reactions of monascorubrin and rubropunctatin with water-soluble amino acid (Journal of Industrial Microbiology, Vol. 16, pp. 163 to 170, 1996).

A monascus dye can be extracted from the culture solution or bacteria fraction with an organic solvent. The supernatant culture solution may be directly used as the dye after being solidified. The useful extractants include n-propyl alcohol, methanol, ethanol, butanol, acetone, ethyl acetate, dioxane and chloroform. For refining the extract, it may be isolated by a common isolation technique, e.g., silica gel chromatography or reverse-phase, high-speed liquid chromatography. It can be refined to produce a monascus dye of desired purity.

The monascus dye thus produced is a mixture of water-insoluble and water-soluble components, the former including monascorubrin, rubropunctatin, ankaflavin, monascin, monascorubramin, and rubropunctamine, and the latter including monascorubrin or rubropunctatin bound to an water-soluble amino compound in the culturing step.

When the cultured monascus dye is incorporated in the ink of the present invention, the supernatant culture solution or its extract may be directly used, as discussed above. However, it is preferably treated with a water-soluble amino compound before being incorporated in the ink, because of accelerated production of a water-soluble complex of monascorubrin or rubropunctatin with the water-soluble amino compound. This procedure increases a water-soluble component content in the dye and thereby to improve color reduction or erasion capacity of the ink for the present invention.

The water-soluble component content in the dye can be increased by the following procedure which incorporates a water-soluble amino compound in the cultured monascus dye. First, a monascus bacterium is cultured under an acidic atmosphere with acetic acid as a pH adjuster being supplied to the medium. The culture under an acidic atmosphere produces a dye massively containing water-insoluble monascorubrin or rubropunctatin while controlling its reactions with a water-soluble amino compound. Then, the culture solution is incorporated with an excessive quantity of a water-soluble amino compound and treated by centrifugal separation or filtration, after being adjusted at a neutral pH level, to recover the bacterium. This produces a dye of increased water-soluble component content. Alternately, the solution which cultures the bacterium under an acidic atmosphere may be treated with an organic solvent to extract a dye containing monascorubrin or rubropunctatin, and the extract is reacted with a water-soluble amino compound. This produces a monascus dye of decreased impurity component, as a mixture of limited number of dyes. When applied to the achromatization method of the present invention, it can improve color reduction or erasion capacity of the ink. The extractants useful for recovering the dye from the culture solution include ethyl acetate, acetone, butanol, ethanol and methanol. Of these extractants, ethyl acetate improves the achromatization effect of the present invention, when the extract is washed with water.

The water-soluble amino compound to be incorporated in the cultured monascus dye is at least one selected from the group consisting of amino acid, water-soluble protein, peptide and nucleic acid compound, or a mixture thereof. Such an amino compound can provide the present invention with an excellent color erasion effect. When the dye is incorporated with a water-soluble amino compound, after being extracted, the extractant is not limited. However, it is recommended to use a 50% by mass aqueous solution of ethanol, methanol or acetonitrile.

Violacein as a natural dye is a microorganism belonging to genus Chromobacterium, Janthinobacterium or Alteromonas. Those having a variant or mutant strain of the above bacterium are also useful.

Violacein may be produced by use of Janthinobacterium lividum (Institute of Physical and Chemical Research's catalog no. JCM9045). It gives a bluish purple dye in a greatly varying yield depending on type of culture medium used. It is recommended that the bacterium is cultured in a medium which gives the dye in a high yield, e.g., that of mannitol YE or semi-synthetic potato, at 5 to 30° C. and pH 6.0 to 8.0. The dye can be extracted from the bacterium with a solvent. The useful extractants include n-propyl alcohol, methanol, ethanol, dioxane and chloroform. For refining the extract, it may be isolated by a common isolation technique, e.g., silica gel chromatography or reverse-phase, high-speed liquid chromatography. It can be refined to produce violacein of desired purity. Moreover, the extract may be directly used, after being concentrated.

The extracted natural dye for the present invention is not limited. Some examples include those extracted from plants, e.g., tumeric, gardenia, carotin, safflower, annatto, capsicum, Japanese basil, grape juice, red radish, red cabbage, purple sweet potato, chlorophyll, cacao and indigo dye plants; and from animals, e.g., lac, cochineal and sepia. Of these, those from gardenia and capsicum give a higher color erasion effect. The synthetic dye useful for the ink for the present invention is not limited. Some examples include those based on anthraquinone, triphenylmethane, phthalocyanine, polyene and indigo.

(Solvent)

The organic solvent working as a liquid medium component to dissolve or disperse a dye for the ink may include organic solvents used for an ink jet ink. More specifically, these solvents include alcohol, glycol, glycol ether, fatty acid ester, ketone, ether, hydrocarbon solvent and polar solvent. Of these, those working as good organic solvents for dissolving or dispersing the above dyes include alcohols, e.g., methanol, ethanol, 1-propanol, 2-propanol, 1-butanol, 2-butanol, isobutyl alcohol or t-butyl alcohol; and glycols, e.g., ethylene glycol, diethylene glycol, triethylene glycol, polyethylene glycol, propylene glycol, dipropylene glycol, polypropylene glycol, butylenes glycol, hexane diol, pentane diol, glycerin, hexane triol and thiodiglycol.

These organic solvents may be used alone or in combination of two or more. Specific examples of the combinations include an alcohol and polar solvent, glycol and polar solvent, and alcohol, glycol and polar solvent. The polar solvents useful for the present invention include 2-pyrrolidone, formamide, N,N-dimethylformamide, N,N-dimethylacetoamide, dimethylsuloxide, sulfolane, N-methyl-2-pyrrolidone, N-vinyl-2-pyrrolidone, 2-oxazolidone, 1,3-dimethyl-2-imidazolidinone, acetonitrile and acetone.

The organic solvent may be incorporated with water, when it is soluble in water. In this case, water is incorporated at 30 to 95% by mass based on the whole ink composition.

A dye, which can be achromatized, may be dispersed or dissolved in the solvent by merely incorporating the dye in the solvent. Alternately, a dye is dispersed in the presence of dispersant (surfactant) after being finely divided by a dispersing machine. Dispersing machines include ball mill, sand mill, attritor, roll mill, agitator mill, Henschel mixer, colloid mill, supersonic homogenizer, pearl mill, jet mill and angmill.

The surfactant for the present invention may be anionic, cationic, amphoteric or nonionic.

The dye is incorporated in the ink at 0.01% by mass or more and 90% by mass or less based on the whole ink composition, preferably 0.5% by mass or more and 15% by mass or less. The ink containing the dye at the content in the above range can form good images on a recording medium. The ink may be incorporated with a binder, pH adjustor, viscosity adjustor, penetrating agent, surface tension adjustor, oxidation inhibitor, preservative or antifungal agent.

<Achromatization of Colored Portion on Printed Matter>

The achromatization method of the present invention exposes a colored portion on a printed matter to a plasma generated by discharging of varying type and an oxidative gas as a secondary product of discharging to achromatize a dye which constitutes the colored portion. It is an essential characteristic of the present invention to treat a surface to be treated of a printed matter having a colored portion spaced from the plasma region. This essentially differentiates the present invention from the conventional plasma treatment which exposes a varying solid surface to a plasma in the plasma region (plasma space) or in an area substantially in contact with the plasma region. The present invention does not directly expose a printed matter to a plasma, and brings it into contact with an oxidative gas without being affected by the plasma region. In short, it allows the oxidative gas generated in the plasma region to exhibit its positive or selective functions by introducing the gas in the contact region while controlling the direct effects of charging species, e.g., ion species or electrons, present in the plasma region on the contact region with the printed matter.

As discussed above, the present invention, unlike the conventional plasma treatment, actively utilizes an acidic gas generated by a plasma for surface treatment. In order to selectively utilize the oxidative gas after separating it from the other ion species and electrons, the surface to be treated is spaced from the plasma region. The surface treatment with the surface spaced from the plasma region is referred to as “remote plasma treatment” in this specification.

In the present invention, a remote plasma device is supplied with a reactive gas from the outside to generate a plasma, by which an oxidative gas is generated. At least one species selected from ozone, hydroxyl radical, carbonate ion and nitrogen oxide present in the oxidative gas generated in the plasma region is actively involved in the dye achromatization. This promotes the chemical reactions for the achromatization. The oxidative gas, represented by ozone, is mostly utilized for the achromatization of a colored portion on a printed matter, and it is possible to keep production of the oxidative gas, represented by ozone, at a necessity minimum level. The present invention, which treats a surface to be treated of a printed matter spaced from the plasma region as the essential characteristic, is suitable for achromatization of printed matter incorporated in electronic devices, represented by IC cards and IC tags.

Means for generating a plasma for the present invention may be selected from known ones, preferably from those for generating discharge plasma by corona discharge, creeping discharge, coplanar discharge or dielectric barrier discharge. It is equipped with means for introducing a reactive gas, e.g., air, oxygen, nitrogen, carbon dioxide, steam or a combination of two or more thereof.

<Device for Achromatizing Colored Portion on Printed Matter>

The dye achromatization device of the present invention exposes a colored portion on a printed matter to an oxidative gas generated by a remote plasma device to achromatize the colored portion. Preferable discharging means for generating an oxidative gas include those producing corona discharge, creeping discharge or dielectric barrier discharge. The achromatization device of the present invention is also equipped with means for supporting a printed matter with which an oxidative gas generated by the remote plasma device is brought into contact. The achromatization device of the present invention is described by referring to the attached drawings, where air is used as a reactive gas.

Corona discharge is generated by applying a voltage between a discharge electrode and opposing counter electrode to generate an oxidative gas. The voltage to be applied to the discharge electrode may be direct or alternating.

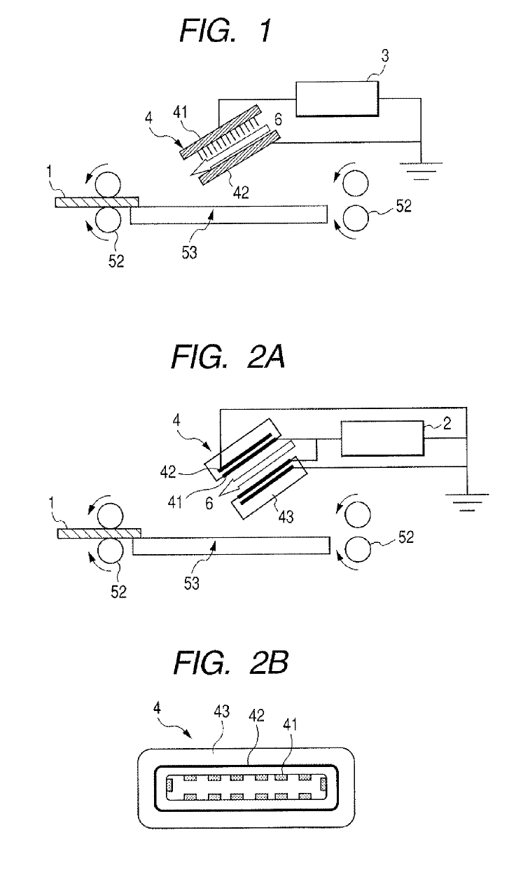

FIG. 1 is a side view schematically illustrating one embodiment of the achromatization device of the present invention, where images (including letters) on a printed matter formed on a recording medium by ink jet recording are achromatized by a remote plasma device which uses corona discharge. Corona discharge is generally generated by applying a voltage between a discharge electrode and an opposing counter electrode.

The device shown in FIG. 1 has a discharge electrode 41 and an electroconductive metallic plate 42 as a counter electrode, the former having needle shapes on one side. It is recommended to ground the electroconductive metallic plate 42, as shown in FIG. 1, to efficiently generate an ionized/dissociated gas and its secondary products. In FIG. 1, reference numeral 3 is DC voltage applying means, and reference numeral 4 is a remote plasma device with the plate-shape discharge electrode 41 and the counter electrode 42. The voltage may be of DC or AC superimposed on DC. Applying a DC voltage of negative polarity on the discharge electrode 41 efficiently helps erase images, conceivably because it efficiently generates a dissociated gaseous composition comprising an ionized/dissociated gas of oxidative gas and its secondary product, effective for achromatizing a dye which constitutes a colored portion.

The discharge electrode 41 and the counter electrode 42 may be made of a metal, e.g., Al, Cr, Au, Ni, Ti, W, Te, Mo, Fe, Co, and Pt, or an alloy or oxide thereof. Corona discharge can be initiated by applying a voltage of a predetermined threshold level (discharge initiation voltage) or more.

The DC voltage to be applied to the discharge electrode for the present invention is preferably in a range from −0.5 to −20 kV, more preferably from −0.5 to −10 kV for more efficient image achromatization.

The image color reduction/erasion is effected in the following manner. First, a reactive gas is introduced into the remote plasma device, where it is sent by a fan (not shown) from backward of the device. The “backward” means an opening located opposite to the port through which an oxidative gas is sprayed, shown in FIG. 1. The reactive gas introduce becomes an oxidative gas in the space between the discharge and counter electrodes. The oxidative gas is sprayed onto a running or stationary printed matter at a rate corresponding to that of the reactive gas. The reactive gas and oxidative gas to be sprayed onto printed matter preferably flow at 0.1 to 5 m/second.

In the present invention, the printed surface is preferably spaced from the plane (center) from which the gas is emitted in the remote plasma device by more than 0 and 100 mm or less. This distance will secure efficient achromatization. The distance is more preferably 5 mm or more and 100 mm or less.

In the present invention, the means for supporting a printed matter may include means for transferring the printed matter into or out of the region in which it is exposed to the oxidative gas. The transferring means is at least one type selected from the group consisting of endless belt, roll and drum. It may run in a unidirectional or back and forth manner or combination thereof. In this invention, a printed matter is preferably stationary or moving at a relative velocity of 2000 cm/minute or less to the plane from which an oxidative gas is emitted in a remote plasma device, in order to efficiently achromatize a colored portion. It is more preferable to move at 600 cm/minute or less, if it moves. In the case where a stationary printed matter is exposed to an oxidative gas, a remote plasma device itself may be moved at the above velocity over the entire surface of the printed matter. The above preferable velocity is given by a relative velocity between the printed matter and remote plasma device.

The discharge electrode 41 is not limited in shape; it may have a shape of needle, roll, blade, plate, brush, wire or bar.

Creeping discharge is triggered by applying an AC voltage between a pair of electrodes spaced from each other via a dielectric, over which discharge creeps to generate an oxidative gas.

FIG. 2A is a side view schematically illustrating another embodiment of the achromatization device of the present invention, where images on a printed matter are achromatized by a remote plasma device which uses creeping discharge. An oxidative gas generated by creeping discharge occurring in air comprises ionized/dissociated gas and its secondary product, e.g., ozone, carbonate ion or nitrogen oxide. In FIG. 2A, a discharge electrode 41 for creeping discharge comprises a pair of a discharge electrode 41 and a counter electrode 42 which are separated by a dielectric 43 opposed to each other.

As illustrated in FIG. 2B, a remote plasma device 4 is cylindrical having an elliptical cross-section in the oxidation gas spraying direction, with the counter electrode 42 being embedded in the dielectric 43 and the discharge electrode 41 being provided on the inner surface of the dielectric 43. An oxidation gas is generated on the inner surface of the dielectric 43 near the discharge electrode 41.

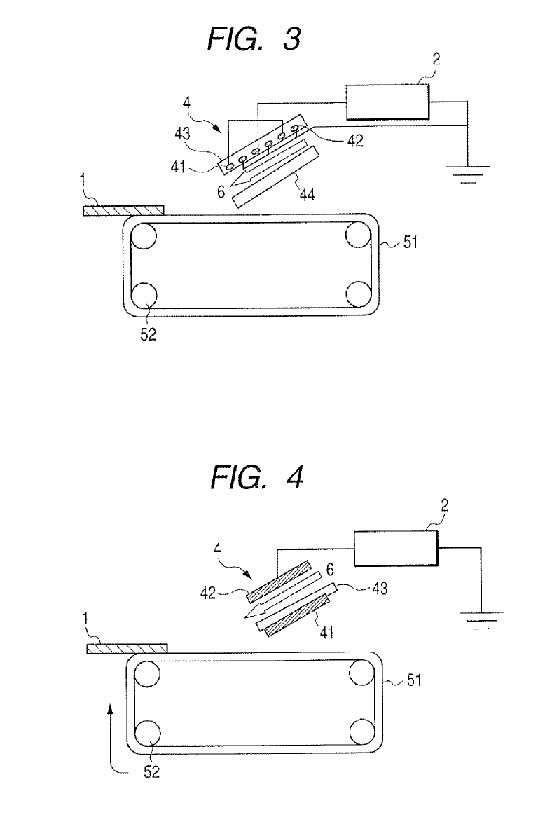

In FIG. 2A, reference numeral 2 is an AC power source. The remote plasma device for generating creeping discharge is not limited in shape. One example is shown in FIG. 3, which illustrates a structure for generating discharge commonly referred to as coplanar discharge having a wire-shaped discharge electrode 41 and counter electrode 42, the former being embedded in a dielectric 43. The electrodes 41 and 42 may be made of a material selected from those used for generating corona discharge, described before. The dielectric 43 is made of a material which can provide a surface on which creeping discharge occurs. Some of the examples include ceramics and glass, e.g., metal oxides represented by silica, magnesia and alumina; and nitrides represented by silicon nitride and aluminum nitride.

The discharge electrode 41 and the counter electrode 42 are spaced from each other preferably by 1 μm or more, more preferably 3 to 200 μm. An AC voltage (Vpp) to be applied to the discharge electrode 41 is preferably in a range from 1 to 20 kV, and preferably has a frequency of 100 Hz to 5 MHz. The combination of the above voltage and frequency can more efficiently generate an oxidative gas. A combination of Vpp of 1 to 10 kV and frequency of 1 kHz to 2 MHz is more preferable.

The image color reduction/erasion with an oxidative gas generated by creep discharge is effected in a manner similar to that for the corona discharge case. A reactive gas is introduced from backward of the remote plasma device 4, and the oxidative gas produced in the discharge space between the discharge electrode and the counter electrode is sprayed onto a running or stationary printed matter.

The achromatization conditions in this case are similar to those in the corona discharge case with respect to the preferable ranges of rate of the reactive gas to be introduced and the oxidative gas to be sprayed, distance between the printed surface and the plane (center) from which the oxidative gas is emitted, and rate at which a printed matter is transferred while being exposed to an oxidative gas.

Dielectric barrier discharge is generated by applying a voltage between a pair of electrodes coated with a dielectric on the inner side of at least one of the electrodes, to generate a plasma of a gas present in the space between the electrodes. It can stably generate a plasma under an atmospheric pressure. Corona discharge and creeping discharge described above can generate an oxidative gas. However, adoption of barrier discharge more improves generation efficiency of an oxidative gas.

FIG. 4 is a side view schematically illustrating one embodiment of the achromatization device of the present invention, where images on a printed matter are achromatized by a remote plasma device which uses dielectric barrier discharge. In FIG. 4, a pair of opposing electrodes, discharge electrode 41 and counter electrode 42 for barrier discharge are spaced from each other via a dielectric 43. As shown in FIG. 4, the remote plasma device 4 is plate-shaped, and generates an oxidative gas in the vicinity of the dielectric 43 and counter electrode 42, when a voltage is applied between the dielectric-coated discharge electrode 41 and the counter electrode spaced from the discharge electrode 41.

A voltage (Vpp) to be applied between the discharge electrode 41 and the counter electrode 42 is preferably in a range from 1 to 40 kV, and preferably has a frequency of 10 Hz to 20 kHz. The combination of the above voltage and frequency can more efficiently generate an oxidative gas. A combination of Vpp of 1 to 30 kV and frequency of 20 Hz to 10 kHz is more preferable. The AC voltage to be applied may have a sinusoidal, triangular, square or pulsed waveform, or a combination thereof.

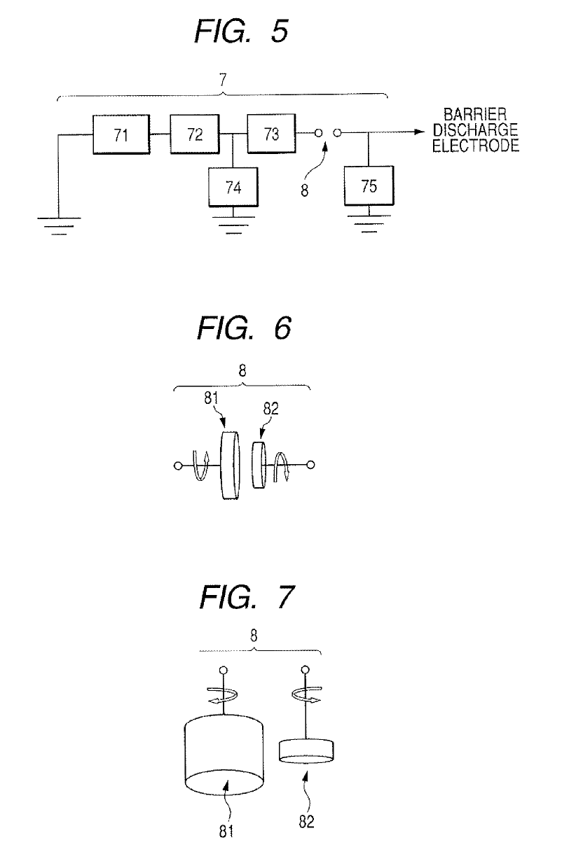

The power source for barrier discharge is not limited, so long as it can produce an AC voltage having a Vpp level of 1 to 40 kV and frequency of 10 Hz to 20 kHz. However, a commercial AC power source which uses a semiconductor is expensive. On the other hand, a power source which uses an aerial gap can decrease the power source cost to one-tenth or less that of the above source. FIG. 5 schematically illustrates one embodiment of power source for the achromatization device of the present invention which generates barrier discharge. It has a simple structure with a commercial transformer 71 as an input power source, electric elements 72 to 75 and an aerial gap 8 connected to each other. Each of the electric elements 72 and 73 is a resistor or coil, and the electric elements 74 and 75 are a capacitance and a resistor, respectively. The aerial gap 8 is composed of a combination of any of needle, flat plate, blade and cylinder. The gap material is not limited, so long as it is electroconductive.

FIG. 6 and FIG. 7 schematically illustrate one embodiment of an aerial gap for the achromatization device of the present invention. Each has plate-shape metallic electrodes 81 and 82 of different size, rotating in the opposite direction to reduce effects of aerial discharge, which may deteriorate the gap. An AC voltage having a Vpp of 1 to 40 kV and frequency of 10 Hz to 20 kHz, including a pulsed waveform, can be generated to secure good barrier discharge by applying an AC voltage of commercial frequency to a transformer 71 and keeping the aerial gap 8 between the plate-shaped metallic electrodes at any value of 10 mm or less. The gap distance, and type and size of the electric elements can be optionally selected in accordance with shape and size of the barrier discharge electrode.

The dielectric barrier discharge electrode may be made of a metal; e.g., Sn, In, Al, Cr, Au, Ni, Ti, W, Te, Mo, Fe, Co, and Pt or an alloy thereof; oxide, e.g., ITO or ZnO; or polymer sheet or rubber belt dispersed with electroconductive particles. Its shape may be plate, mesh, belt, drum or linear. The electrodes may have a different shape.

The dielectric 43 which coats the electrode is made of a discharging material, e.g., carbon compound, ceramic, glass, ferroelectric material or polymer. More specifically, the dielectric materials include diamond and diamond-like carbon; metal oxides represented by silica, magnesia, alumina and zirconia; nitrides represented by silicon nitride and aluminum nitride; and magnesium titanate, barium titanate, lead zirconate titanate, polyethylene, vinyl chloride, polyethylene terephthalate, acryl, polycarbonate and polyvinylidene fluoride.

The dielectric can be applied in such a manner that the above material may be put on the electrode after being formed into a sheet, or may be coated with an electrode layer by ion plating carried out under a vacuum. Moreover, it may be applied in the form of composite composed of the above materials dispersed in a binder. The image color reduction/erasion with an oxidative gas generated in the discharge space between the discharge and counter electrodes is effected in a manner similar to that for the corona discharge case, where a reactive gas is introduced from backward of the remote plasma device 4, and the oxidative gas produced by the device is sprayed onto a running or stationary printed matter.

The achromatization conditions in this case are similar to those in the corona discharge case with respect to the preferable ranges of rate of the reactive gas to be introduced and the oxidative gas to be sprayed, distance between the printed surface and the plane (center) from which the oxidative gas is emitted in the remote plasma device, and rate at which a printed matter is transferred while being exposed to an oxidative gas.

<Time Required for Achromatization>

Images and letters formed by dye-containing colored portions on a printed matter can be discolored (reduced in color) by exposing them to an oxidative gas, preferably to an invisible extent. In other words, color of a dye present on or near a printed matter surface becomes faint, eventually to an invisible extent, by being exposed to an oxidative gas. Dye achromatization is greatly depends on discharge voltage. However, time required for achromatization varies depending on various conditions, e.g., oxidative gas concentration, contact efficiency with an oxidative gas, rate and composition of an oxidative gas, type, concentration and composition of a dye, recording medium material. Achromatization time can be controlled by selecting these conditions. When dye concentration on a printed matter is determined by a line or image sensor prior to the achromatization treatment by a remote plasma device, time for which the printed matter is exposed to an oxidative gas can be varied depending on dye concentration, to achieve uniform achromatization at any concentration.

As discussed above, it is preferable to introduce a reactive gas from backward of a remote plasma device at a rate of 0.1 to 5 m/second to generate an oxidative gas in a discharge space between a discharge electrode and a counter electrode, and to spray the oxidative gas onto a running or stationary printed matter. Exposure of a printed matter to an oxidative gas may be optionally achieved in a closed or open system, depending on a purpose. A close system is more preferable for the present invention to prevent leakage of the oxidative gas from the device. The system, whether it is closed or open, is preferably equipped with an adsorption filter to prevent leakage of the oxidative gas.

When a printed matter is exposed to an oxidative gas in a closed system, a remote plasma device is preferably provided with a feedback mechanism to keep ozone concentration at a constant level. Ozone concentration can be determined by UV absorptiometry in the remote plasma device by comparing the gas with a reference gas. It is preferable to keep an ozone concentration at 100 ppm or more in the device for the achromatization. It is also preferable to swiftly generate an oxidative gas by operating a discharger in the remote plasma device, when the ozone concentration is below the above level.

On completion of the achromatization of a printed matter by the present invention, the discharger is preferably heated up by increasing voltage or frequency applied to the discharger to decompose ozone unnecessary for the achromatization. The atmosphere temperature is preferably kept at 100° C. or higher to efficiently decompose ozone.

<Method for Recycling Recording Medium>

The method of the present invention for recycling a recording medium from a printed matter is not limited, so long as it comprises a step for the achromatization of the present invention. It uses an oxidative gas to accelerate cleavage of a dye in an ink fixed on a printed matter, and can efficiently, easily and quickly achromatize the dye on a printed matter.

In the present invention, a printed matter is preferably kept at 20° C. or higher and 50% RH or more in a steam atmosphere before it is exposed to an oxidative gas generated by dielectric barrier discharge, because the steam treatment accelerates separation of the dye on the printed matter in the form of monomolecular state and thereby to achromatize the dye more efficiently, easily and quickly.

Moreover, the present invention can leave no dye-oxidizing substance on the recycled recording medium. Therefore, it allows the recycled medium to be reused, because a dye in a fresh ink fixed on the achromatized dye can retain its color without being cleaved.

### EXAMPLES

The Present invention is described in more detail by EXAMPLES, which by no means limit the technical scope of the present invention.

### Recording Medium Preparation Example 1

An 85/15 by mass mixture of fine alumina powder (Cataloid® AP-3, Catalyst and Chemical Ind.) and polyvinyl alcohol (SMR-10HH®, Shin-Etsu Chemical) was prepared, and incorporated with water to have a solid content of 20% by mass and stirred. It was spread on a PET film to 30 g/m² (dry basis), and dried at 110° C. for 10 minutes. The resulting recording medium was named RECORDING MEDIUM 1.

### Recording Medium Preparation Example 2

A 2 L stirrer-equipped flask was charged with the following components, which were stirred at room temperature for 30 minutes to prepare a uniform mixture. It was heated at 80° C. for 2 hours and then cooled to have a viscous, transparent liquid (BINDER A):

polyethylene glycol (average molecular weight: 2000), 800 g

hexamethylene diisocyanate, 65 g

dibutyl tin laurate, 2 g and

ethylene glycol dimethyl ether, 900 g.

The liquid prepared had a viscosity of 30,000 mPa·s at 25° C., and the polymer in ethylene glycol dimethyl ether as a solvent had a number-average molecular weight of 85,000.

Next, RECORDING MEDIUM 2 was prepared in the same manner as in RECORDING MEDIUM PREPARATION EXAMPLE 1, except that polyvinyl alcohol was used as BINDER A obtained in the above procedure.

### Recording Medium Preparation Example 3

A 2 L stirrer-equipped flask was charged with 300 g of hydroxyethyl methacrylate, 350 g of water, 350 g of methanol and 1.5 g of azobisisobutylonitrile, which were stirred at room temperature for 60 minutes. Then, the flask was thoroughly purged with a nitrogen gas, and the resulting mixture was heated to 65° C. in the presence of nitrogen gas flown slowly, and kept at this temperature for 3 hours for polymerization. The resulting polymer was cooled to have a viscous, transparent liquid (BINDER B). The liquid prepared had a viscosity of 1,800 mPa·s at 25° C., and the polymer in the mixed solvent of water/methanol had a number-average molecular weight of 150,000. Next, RECORDING MEDIUM 3 was prepared in the same manner as in RECORDING MEDIUM PREPARATION EXAMPLE 1, except that polyvinyl alcohol was used as BINDER B obtained in the above procedure.

### Recording Medium Preparation Example 4

An 85/15 by mass mixture of colloidal silica (Snowtex® C, Nissan Chemical) and polyvinyl alcohol (SMR-10HH®, Shin-Etsu Chemical) was prepared, and incorporated with water to have a solid content of 20% by mass and stirred. It was spread on a PET film to 30 g/m² (dry basis), and dried at 110° C. for 10 minutes, to prepare RECORDING MEDIUM 4.

### Ink Preparation Examples 1 to 5

Inks (INKS 1 to 5) each having a composition given in Table 1 were prepared, where the components were thoroughly stirred to have solutions, which were filtered under pressure by a filter (pore size: 0.45 μm, Fluoroporefilter®, Sumitomo Electric). Copper phthalocyanine tetrasodium tetrasulfonate was supplied by Kishida Reagents Chemicals, gardenia yellow dye and capsicum dye and chlorophyll by Kiriya Chemical, and indigo carmine by Nacalai Tesque.

TABLE 1

| | INK 1 | INK 2 | INK 3 | INK 4 | INK 5 |
|---|---|---|---|---|---|
| Copper | 2.5 | | | | |
| phthalocyanine | | | | | |
| tetrasodium | | | | | |
| tetrasulfonate | | | | | |
| Gardenia yellow dye | | 2.5 | | | |
| Capsicum dye | | | 2.5 | | |
| Chlorophyll | | | | 2.5 | |
| Indigo carmine | | | | | 2.5 |
| Glycerin | 7.5 | 7.5 | 7.5 | 7.5 | 7.5 |
| Diethylene glycol | 7.5 | 7.5 | 7.5 | 7.5 | 7.5 |
| *Acetylenol EH | 0.1 | 0.1 | 0.1 | 0.1 | 0.1 |
| Water | 82.4 | 82.4 | 82.4 | 82.4 | 82.4 |

(Unit: % by mass)
*Acetylenol EH ®: Ethylene oxide adduct of acetylene alcohol (HLB = 14 to 15, Kawaken Fine Chemicals)

### Ink Preparation Example 6

A 500 mL Sakaguchi flask was charged with 100 mL of a malt/yeast extract YE culture medium [glucose: 1 mass %, yeast extract (Difco Laboratories, Inc.) 0.3 mass %, malt extract (Difco Laboratories, Inc.) 0.3 mass %, bacto peptone (Difco Laboratories, Inc.): 0.5 mass % and pure water: balance.] which was adjusted at a pH of 6.5. The medium was sterilized at 120° C. for 20 minutes under pressure. It was cooled and inoculated with a loopful of monascus bacterium (Monascus purpureus, NBRC 4478) slant-cultured in a YM agar medium. The bacterium was cultured at 30° C. for 2 days while the medium was vibrated to prepare a seed bacterium solution. Then, 5 mL of the seed bacterium solution obtained was inoculated in 100 mL of a YM medium, sterilized in the same manner, and cultured as a main culture for dye production at 30° C. for 3 days while the medium was vibrated. After the completion of the main culture, the culture solution was treated by a centrifugal separator (9,000 rpm) for 10 minutes to be separated into a supernatant solution and a bacterium body. The supernatant solution, diluted 100 times with distilled water, had an absorbance of 0.2 at a wavelength of 500 nm. The supernatant solution was mixed with the same volume of ethanol and stirred. The resulting mixture was treated by a centrifugal separator (9,000 rpm) for 10 minutes to separate a water-insoluble dye. The resulting supernatant solution was concentrated and solidified to prepare a water-soluble red dye. Then, 10.0 parts of the dye was mixed with 90.0 parts of ethanol, thoroughly stirred to have a solution, which was filtered under pressure by a filter (pore size: 0.45 μm, Fluoroporefilter®, Sumitomo Electric) to prepare INK 6.

### Culture Examples 1 to 4

In each of CULTURE EXAMPLES 1 to 4, a 5 L Shaking flask (Sakaguchi flask) was charged with 1 L of the same YM medium as used in INK PREPARATION EXAMPLE 6, and sterilized at 120° C. for 20 minutes under pressure, after it was adjusted at a pH of 6.5. It was cooled and inoculated with a loopful of monascus bacterium (Monascus purpureus, NBRC 4478) slant-cultured in a YM agar medium. The bacterium was cultured at 30° C. for 2 days while the medium was vibrated to prepare a seed bacterium solution.

On the other hand, 1 L glass jar was charged with 450 mL of the same YM medium, which was sterilized at 120° C. for 20 minutes under pressure. It was cooled and inoculated with the above seed bacterium solution at 10% by volume. Sulfuric acid, phosphoric acid and acetic acid were used as pH adjustors for CULTURE EXAMPLES 1, 2 and 3, respectively. The culture solution was stirred by aeration at 30° C. for 7 days while it was kept at a pH of 4.0 after the culturing was started. CULTURE EXAMPLE 4 adjusted the solution at a pH of 6.5 when the culturing was started, and then kept the pH level unadjusted. Production rate of monascorubrin in the culture solution prepared in each of CULTURE EXAMPLES 1 to 4 was determined by HPLC in accordance with the procedure described in the International Publication 02/088265 pamphlet. The results are given in Table 2.

TABLE 2

| | | | Monascorubrin |
|---|---|---|---|
| | | Controlled pH | production rate |
| | PH adjuster | level | (mg/L) |
| CULTURE | Sulfuric acid | 4.0 | 220.5 |
| EXAMPLE 1 | | | |
| CULTURE | Phosphoric | 4.0 | 259.6 |
| EXAMPLE 2 | acid | | |
| CULTURE | Acetic acid | 4.0 | 953.5 |
| EXAMPLE 3 | | | |
| CULTURE | No adjuster | No adjuster | 7.4 |
| EXAMPLE 4 | used | used | |

As shown in Table 2, monascorubrin production rate was notably increased when it was cultured in an acidic condition, and acetic acid as a pH adjuster produced monascorubrin in a still higher yield than a mineral acid of sulfuric or phosphoric acid. Rubropunctatin and monascorubrin, cultured by this method, gave a water-soluble dye more efficiently, when they were reacted by an amino compound by addition reaction.

### Ink Preparation Example 7

The culture solution prepared in CULTURE EXAMPLE 3 was treated by a centrifugal separator (9,000 rpm) for 10 minutes to be separated into a supernatant solution and a bacterium body. The resulting dye-containing wet bacterium body, when freeze-dried, contained moisture at 75.6% by mass.

Then, 400 g of the resulting wet bacterium body was incorporated with 10 L of ethyl acetate and stirred for 1 hour. The mixture was filtered by a filter paper to be separated into a filtrate and a bacterium body. The filtrate was treated to separate the ethyl acetate layer from the aqueous layer. The ethyl acetate extract solution was washed with the same volume of water twice. The washed ethyl acetate extract solution was concentrated and solidified to prepare a reddish orange dye containing monascorubrin and rubropunctatin.

Next, 10.8 g of the reddish orange dye was incorporated with acetonitrile to prepare 2095 mL of the acetonitrile solution containing the reddish orange dye. It was reacted with the same volume of a 30 mg/mL aqueous monosodium glutamate solution at room temperature for 3 days with stirring, and the product was concentrated and solidified to prepare a water-soluble dye. The dye was mixed with glycerin, diethylene glycol, acetylenol and water with sufficiently stirring to prepare a 2.5 (dye)/7.5/7.5/0.1/82.4 by mass solution. The resulting solution was filtered under pressure by a filter (pore size: 0.45 μm, Fluoroporefilter®, Sumitomo Electric) to prepare INK 7.

On completion of the reaction with monosodium glutamate to prepare the water-soluble dye, the reaction solution was analyzed by reverse-phase HPLC, which detected neither monascorubrin nor rubropunctatin. Moreover, the reaction solution, diluted 100 times with distilled water, was analyzed for absorbance at 500 nm. It was 0.68.

### Printed Matter Preparation Examples 1 to 10

Each of RECORDING MEDIA 1 to 4 was solid-printed with one of INKS 1 to 7 by an on-demand ink jet printer (PIXUS iP3100, Canon) with a heating element as an ink ejecting energy source to prepare PRINTED MATTERS 1 to 10. Table 3 describes these printed matters.

TABLE 3

| | Base | INK |
|---|---|---|
| PRINTER MATTER 1 | 1 | 1 |
| PRINTER MATTER 2 | 2 | 1 |
| PRINTER MATTER 3 | 3 | 1 |
| PRINTER MATTER 4 | 4 | 1 |
| PRINTER MATTER 5 | 1 | 2 |
| PRINTER MATTER 6 | 1 | 3 |
| PRINTER MATTER 7 | 1 | 4 |
| PRINTER MATTER 8 | 1 | 5 |
| PRINTER MATTER 9 | 1 | 6 |
| PRINTER MATTER 10 | 1 | 7 |

<Evaluation of Color Erasion/Reduction Capacity>

### Examples 1 to 10

Color erasion/reduction capacity was tested using a remote plasma device shown in FIG. 1, which had the following characteristics; size of the discharge electrode 41 and counter electrode 42, both of nickel: 225 by 100 by 1 mm (thickness); distance between the electrodes: 5 mm; length of needles on the discharge electrode 41: 1 mm; and needle density: 144 needles/cm². Each of PRINTED MATTERS 1 to 10 was discharge-treated while it was transferred at 60 cm/minute in the closed remote plasma device, where a DC voltage of −3 kV was applied to the discharge electrode 41 and air was introduced at 1.2 m/second (EXAMPLES 1 to 10). The remote plasma device 4 and the plate 53 were arranged to have a distance of 10 mm between the center of the plane from which an oxidative gas was emitted in the remote plasma device and the printed matter. Concentration of ozone on the plane from which the oxidative gas was emitted was measured by an ozone concentration meter (Model 1300, Tokyo Dylec). It was about 100 ppm.

Optical density of each of PRINTED MATTERS 1 to 10 was measured by a color transmission/reflection concentration meter (X-Rite310TR®, X-Rite Inc.) before and after the discharge treatment. Ratio of the optical density after the discharge treatment to that before the treatment is defined as residual optical density rate, which was determined by the following formula:
Residual optical density rate=(Optical density after the discharge treatment/Optical density before the discharge treatment)×100.
The results are given in Table 4.

### Example 11

PRINTED MATTER 10 was discharge-treated in the same manner as in EXAMPLE 1 using the same remote plasma device, except that a DC voltage of −4 kV was applied to the discharge electrode, and its residual optical density rate was determined. The result is given in Table 4. Concentration of ozone on the plane from which the oxidative gas was emitted was about 140 ppm, as measured by an ozone concentration meter (Model 1300, Tokyo Dylec).

### Examples 12 to 21

Color erasion/reduction capacity was tested using a remote plasma device shown in FIG. 2B, which had the following characteristics; size of the dielectric 43 of alumina ceramic having an elliptical cross-section: 250 mm in diameter (major axis) by 30 mm in diameter (minor axis) by 70 mm in length and 1 mm in thickness; the counter electrode 42 embedded in the dielectric was made of tungsten; the discharge electrode 41 was made of tungsten having an outer diameter of 0.4 mm; and distance between the electrodes: 0.5 mm. Each of PRINTED MATTERS 1 to 10 was discharge-treated while it was transferred at 150 cm/minute in the closed remote plasma device, where a voltage of 3 kV as Vpp having a square waveform and frequency of 15 kHz was applied and air was introduced at 2 m/second. The residual optical density rate was determined in the same manner as in EXAMPLE 1 (EXAMPLES 12 to 21). The results are given in Table 5. The remote plasma device 4 and the plate 53 were arranged to have a distance of 30 mm between the center of the plane from which the oxidative gas was emitted in the remote plasma device and the printed matter. Concentration of ozone on the plane from which the oxidative gas was emitted was about 200 ppm, as measured by an ozone concentration meter (Model 1300, Tokyo Dylec).

### Comparative Example 1

Light recycled paper (Fuji Xerox) was solid-printed with INK 7 by an on-demand ink jet printer (PIXUS iP3100, Canon) with a heating element as an ink jetting energy source to prepare PRINTED MATTER 12. It was discharge-treated in the same manner as in EXAMPLE 1 using the same device to determine its residual optical density rate. The result is given in Table 5.

### Comparative Example 2

PRINTED MATTER 10 was placed 25 cm under a daylight color fluorescent lamp and irradiated with light (2000 lux) for 20 hours to determine its residual optical density rate. The result is given in Table 5.

TABLE 4

| | | | Residual |
|---|---|---|---|
| | | | optical |
| | Recording | | density rate |
| | medium | Dye in ink | (%) |
| EXAMPLE | Alumina-coated | Copper | 77 |
| 1 | paper | phthalocyanine | |
| | | tetrasodium | |
| | | tetrasulfonate | |
| EXAMPLE | Alumina-coated | Copper | 59 |
| 2 | paper | phthalocyanine | |
| | | tetrasodium | |
| | | tetrasulfonate | |
| EXAMPLE | Alumina-coated | Copper | 56 |
| 3 | paper | phthalocyanine | |
| | | tetrasodium | |
| | | tetrasulfonate | |
| EXAMPLE | Silica-coated | Copper | 47 |
| 4 | paper | phthalocyanine | |
| | | tetrasodium | |
| | | tetrasulfonate | |
| EXAMPLE | Alumina-coated | Gardenia yellow | 10 |
| 5 | paper | dye | |
| EXAMPLE | Alumina-coated | Capsicum dye | 16 |
| 6 | paper | | |
| EXAMPLE | Alumina-coated | Chlorophyll | 41 |
| 7 | paper | | |
| EXAMPLE | Alumina-coated | Indigo carmine | 14 |
| 8 | paper | | |
| EXAMPLE | Alumina-coated | Monascus dye | 10 |
| 9 | paper | | |
| EXAMPLE | Alumina-coated | Monascus dye | 12 |
| 10 | paper | | |
| EXAMPLE | Alumina-coated | Monascus dye | 9 |
| 11 | paper | | |

TABLE 5

| | | | Residual |
|---|---|---|---|
| | | | optical |
| | Recording | | density rate |
| | medium | Dye in ink | (%) |
| EXAMPLE 12 | Alumina- | Copper | 75 |
| | coated paper | phthalocyanine | |
| | | tetrasodium | |
| | | tetrasulfonate | |
| EXAMPLE 13 | Alumina- | Copper | 51 |
| | coated paper | phthalocyanine | |
| | | tetrasodium | |
| | | tetrasulfonate | |
| EXAMPLE 14 | Alumina- | Copper | 50 |
| | coated paper | phthalocyanine | |
| | | tetrasodium | |
| | | tetrasulfonate | |
| EXAMPLE 15 | Silica- | Copper | 42 |
| | coated paper | phthalocyanine | |
| | | tetrasodium | |
| | | tetrasulfonate | |
| EXAMPLE 16 | Alumina- | Gardenia yellow | 8 |
| | coated paper | dye | |
| EXAMPLE 17 | Alumina- | Capsicum dye | 13 |
| | coated paper | | |
| EXAMPLE 18 | Alumina- | Chlorophyll | 36 |
| | coated paper | | |
| EXAMPLE 19 | Alumina- | Indigo carmine | 9 |
| | coated paper | | |
| EXAMPLE 20 | Alumina- | Monascus dye | 6 |
| | coated paper | | |
| EXAMPLE 21 | Alumina- | Monascus dye | 7 |
| | coated paper | | |
| COMPARATIVE | Common paper | Monascus dye | 99 |
| EXAMPLE 1 | | | |
| COMPARATIVE | Common paper | Monascus dye | 20 |
| EXAMPLE 2 | | | |

These results clearly indicate that EXAMPLES 1 to 21 reduced residual optical density rates to a low level, demonstrating excellent color erasion/reduction capacity of each printed matter printed with an ink jet ink with images formed on the recording medium coated with the inorganic pigment, because it was exposed to an oxidative gas generated by the remote plasma device. The capacity is particularly noted when the monascus dye, gardenia yellow dye, capsicum dye and indigo dye are used. It is also noted that the recording medium coated with alumina as an inorganic pigment gives higher color erasion/reduction capacity.

### Recording Medium Preparation Examples 5 to 8

A mixture of fine colloidal silica powder and polyvinyl alcohol (SMR-10HH®, Shin-Etsu Chemical) with a ratio of 85/15 by weight was prepared, and incorporated with water to have a solid content of 20% by mass and stirred. It was spread on a common paper (A4 size) to 35 g/m² (dry basis), and dried at 110° C. for 10 minutes, to prepare RECORDING MEDIA 5 to 8. The inorganic powder on each of the recording media was analyzed for its pore volume and dispersed particle diameter by the procedure described above. The results are given in Table 6.

TABLE 6

| | Pore volume of silica | Dispersed silica |
|---|---|---|
| | powder [cc/g] | particle diameter [μm] |
| Recording | 0.2 | 0.9 |
| medium 5 | | |
| Recording | 0.3 | 0.6 |
| medium 6 | | |
| Recording | 0.4 | 0.3 |
| medium 7 | | |
| Recording | 0.5 | 0.2 |
| medium 8 | | |

### Recording Medium Preparation Examples 9 to 13

A mixture of fine alumina powder of varying type and polyvinyl alcohol (SMR-10HH®, Shin-Etsu Chemical) with a ratio of 85/15 by weight was prepared, and incorporated with water to have a solid content of 20% by mass and stirred. Each was spread on a common paper (A4 size) to 30 g/m² (dry basis), and dried at 110° C. for 10 minutes, to prepare RECORDING MEDIA 9 to 13. The inorganic powder on each of the recording media was analyzed for its pore volume and dispersed particle diameter by the procedure described above. The results are given in Table 7.

TABLE 7

| | Pore volume of silica | Dispersed silica |
|---|---|---|
| | powder [cc/g] | particle diameter [μm] |
| Recording | 0.2 | 0.8 |
| medium 9 | | |
| Recording | 0.4 | 0.7 |
| medium 10 | | |
| Recording | 0.6 | 0.2 |
| medium 11 | | |
| Recording | 0.7 | 0.1 |
| medium 12 | | |
| Recording | 0.9 | 0.08 |
| medium 13 | | |

### Ink Preparation Examples 8 to 10

Inks each having a composition given in Table 8 were prepared, where the components were thoroughly stirred to have solutions, which were filtered under pressure by a filter (pore size: 0.45 μm, Fluoroporefilter®, Sumitomo Electric). Gardenia yellow and capsicum dyes were supplied by Kiriya Chemical, and copper phthalocyanine tetrasodium tetrasulfonate by Kishida Reagents Chemicals.

TABLE 8

| | INK 8 | INK 9 | INK 10 |
|---|---|---|---|
| Gardenia blue dye | 2.5 | — | — |
| Capsicum dye | — | 2.5 | — |
| Copper phthalocyanine | — | — | 2.5 |
| tetrasodium tetrasulfonate | | | |
| Glycerin | 7.5 | 7.5 | 7.5 |
| Diethylene glycol | 7.5 | 7.5 | 7.5 |
| Acetylenol EH | 0.1 | 0.1 | 0.1 |
| Water | 82.4 | 82.4 | 82.4 |

### Printed Matter Preparation Examples 13 to 24

Each of RECORDING MEDIA 5 to 8 was solid-printed with one of INKS 8 to 10 in the same manner as in PRINTED MATTER PREPARATION EXAMPLES 1 to 10 to prepare PRINTED MATTERS 13 to 24. Dye ionization potential was determined for the solid dye before it was used for printing and the dye on a printed matter by an aerial photoelectron spectrometer (e.g., AC-1, Riken Keiki), where the sample was irradiated with light having an intensity of 10 nW (5.9 eV energy) or more. The results are given in Table 9.

### Printed Matter Preparation Examples 25 to 34

Each of RECORDING MEDIA 9 to 13 was solid-printed with INK 5 or 6 in the same manner as in PRINTED MATTER PREPARATION EXAMPLES 1 to 10 to prepare PRINTED MATTERS 25 to 34. Dye ionization potential was determined for each of these printed matters. The results are given in Table 10.

<Evaluation of Color Reduction/Erasion Capacity>

### Examples 22 to 33

Color reduction/erasion capacity was tested using a remote plasma device shown in FIG. 3, which had the following characteristics; size of the plate-shape dielectric 43 made of alumina ceramic: 225 by 60 by 1 mm (thickness); the discharge electrode 41 and the counter electrode 42, both made of tungsten and embedded in the dielectric: 0.15 mm in outer diameter; and distance between the electrodes: 1.5 mm. The cover 44 was made of a 2 mm thick acrylic plate, and distance between the cover 44 and the plate-shape dielectric 43 was 2 mm. Each of PRINTED MATTERS 13 to 24 was discharge-treated while it was transferred at 120 cm/minute in the closed remote plasma device, where an AC voltage of 4 kV as Vpp having a triangular waveform and frequency of 10 kHz was applied to the discharge electrode and air was introduced at 1.8 m/second in EXAMPLES 22 to 33. The remote plasma device 4 and the belt 51 were arranged to have a distance of 20 mm between the center of the plane from which an oxidative gas was emitted in the remote plasma device and the printed matter. Concentration of ozone on the plane from which the oxidative gas was emitted was about 160 ppm, as measured by an ozone concentration meter (Model 1300, Tokyo Dylec).

The residual optical density rate was measured in the same manner as in EXAMPLE 1. The results are given in Table 9.

### Examples 34 to 43

Color reduction/erasion capacity was tested using a remote plasma device shown in FIG. 4, which had the following characteristics; size of the dielectric 43 made of single-crystal magnesia: 250 by 60 by 0.5 mm (thickness); size of the discharge electrode 41 of chromium provided on the dielectric 43: 225 by 50 by 1 mm (thickness); size of the counter electrode 42 of stainless steel plate: 225 by 50 by 1 mm (thickness); and distance between the dielectric 43 and the counter electrode 42: 2 mm. Each of PRINTED MATTERS 13 to 24 was achromatization-treated in the closed system (EXAMPLES 34 to 43), where the AC power source shown in FIG. 5 was used and the aerial gap had a structure shown in FIG. 7. The electric elements 72, 73, 74 and 75 were of 100 kΩ, 10 kΩ, 1000 pF and 10 kΩ. Distance between the metallic electrodes in the aerial gap 8 was set at 2 mm. Each printed matter was discharge-treated while it was transferred at 180 cm/minute and air was introduced at 1.5 m/second, where an AC voltage (100 V, 50 Hz) was applied to an inverter neon transformer (M-5, RECIP CORP.) to apply an AC voltage (34 kV as Vpp and 50 Hz) including a pulsed waveform to the discharge electrode. The remote plasma device 4 and the belt 51 were arranged to have a distance of 25 mm between the center of the plane from which an oxidative gas was emitted in the remote plasma device 4 and the printed matter. Concentration of ozone on the plane from which the oxidative gas was emitted was about 200 ppm, as measured by an ozone concentration meter (Model 1300, Tokyo Dylec).

The residual optical density rate was measured in the same manner as in EXAMPLE 1. The results are given in

TABLE 10
Table 9

| | | | Ionization | | |
|---|---|---|---|---|---|
| | | | potential | Ionization | Residual |
| | | | of dye | potential | optical |
| | Recording | | powder | of image | density |
| | medium | Dye in ink | (eV) | (eV) | rate (%) |
| EXAMPLE | RECORDING | Gardenia blue | 5.3 | 5.2 | 20 |
| 22 | MEDIUM 5 | dye | | | |
| EXAMPLE | RECORDING | Gardenia blue | 5.3 | 5.17 | 17 |
| 23 | MEDIUM 6 | dye | | | |
| EXAMPLE | RECORDING | Gardenia blue | 5.3 | 5.1 | 13 |
| 24 | MEDIUM 7 | dye | | | |
| EXAMPLE | RECORDING | Gardenia blue | 5.3 | 5.05 | 10 |
| 25 | MEDIUM 8 | dye | | | |
| EXAMPLE | RECORDING | Capsicum dye | 5.95 | 5.85 | 16 |
| 26 | MEDIUM 5 | | | | |
| EXAMPLE | RECORDING | Capsicum dye | 5.95 | 5.79 | 13 |
| 27 | MEDIUM 6 | | | | |
| EXAMPLE | RECORDING | Capsicum dye | 5.95 | 5.7 | 11 |
| 28 | MEDIUM 7 | | | | |
| EXAMPLE | RECORDING | Capsicum dye | 5.95 | 5.65 | 9 |
| 29 | MEDIUM 8 | | | | |
| EXAMPLE | RECORDING | Copper | 6.05 | 6.02 | 76 |
| 30 | MEDIUM 5 | phthalocyanine | | | |
| | | tetrasodium | | | |
| | | tetrasulfonate | | | |
| EXAMPLE | RECORDING | Copper | 6.05 | 6.0 | 65 |
| 31 | MEDIUM 6 | phthalocyanine | | | |
| | | tetrasodium | | | |
| | | tetrasulfonate | | | |
| EXAMPLE | RECORDING | Copper | 6.05 | 5.98 | 59 |
| 32 | MEDIUM 7 | phthalocyanine | | | |
| | | tetrasodium | | | |
| | | tetrasulfonate | | | |
| EXAMPLE | RECORDING | Copper | 6.05 | 5.95 | 55 |
| 33 | MEDIUM 8 | phthalocyanine | | | |
| | | tetrasodium | | | |
| | | tetrasulfonate | | | |

TABLE 10

| | | | Ionization | | |
|---|---|---|---|---|---|
| | | | potential | Ionization | Residual |
| | | | of dye | potential | optical |
| | Recording | Dye in | powder | of image | density |
| | medium | ink | (eV) | (eV) | rate (%) |
| EXAMPLE | RECORDING | Monascus | 5.45 | 5.35 | 16 |
| 34 | MEDIUM 9 | dye | | | |
| EXAMPLE | RECORDING | Monascus | 5.45 | 5.31 | 13 |
| 35 | MEDIUM 10 | dye | | | |
| EXAMPLE | RECORDING | Monascus | 5.45 | 5.28 | 10 |
| 36 | MEDIUM 11 | dye | | | |
| EXAMPLE | RECORDING | Monascus | 5.45 | 5.24 | 8 |
| 37 | MEDIUM 12 | dye | | | |
| EXAMPLE | RECORDING | Monascus | 5.45 | 5.21 | 6 |
| 38 | MEDIUM 13 | dye | | | |
| EXAMPLE | RECORDING | Indigo | 5.85 | 5.71 | 22 |
| 39 | MEDIUM 9 | carmine | | | |
| EXAMPLE | RECORDING | Indigo | 5.85 | 5.56 | 16 |
| 40 | MEDIUM 10 | carmine | | | |
| EXAMPLE | RECORDING | Indigo | 5.85 | 5.5 | 11 |
| 41 | MEDIUM 11 | carmine | | | |
| EXAMPLE | RECORDING | Indigo | 5.85 | 5.38 | 9 |
| 42 | MEDIUM 12 | carmine | | | |
| EXAMPLE | RECORDING | Indigo | 5.85 | 5.33 | 7 |
| 43 | MEDIUM 13 | carmine | | | |

The above results were with the dyes having an ionization potential of 6.0 eV or less in the powder state. As shown, the ink exhibits excellent color erasion/reduction capacity when the dye in the ink fixed on the recording medium has an ionization potential lower than that of the solid (powder) ink by 0.1 eV or more. It is also shown that a monascus, gardenia and capsicum dyes give an ink of excellent color erasion/reduction capacity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-289107, filed Sep. 30, 2005, which is hereby incorporated by reference herein in its entirety.

What is claimed is:

1. An achromatizing method for achromatizing a dye on a printed matter, comprising exposing the dye to an oxidative gas generated by using a remote plasma device.

2. The achromatizing method according to claim 1, wherein the remote plasma device produces the oxidative gas by corona discharge, creeping discharge or dielectric barrier discharge as discharging means, and a printed surface of the printed matter is spaced from a plane from which the oxidative gas generated by the remote plasma device is emitted by more than 0 mm and 100 mm or less.

3. The achromatizing method according to claim 1, wherein the printed matter is stationary or moving at a relative velocity of 2000 cm/minute or less to the plane from which the oxidative gas is emitted in the remote plasma device.

4. The achromatizing method according to claim 1, wherein the printed matter is produced by applying a dye-containing ink to a recording medium to form a colored portion thereon, and the recording medium contains a porous inorganic pigment in its surface.

5. The achromatizing method according to claim 1, wherein the dye has a polyene structure.

6. The achromatizing method according to claim 4, wherein the ink is applied to the recording medium by an ink jet recording method.

7. An achromatization device for achromatizing a dye on a printed matter, comprising a remote plasma device having means which produces an oxidative gas by any discharging means of corona discharge, creeping discharge and dielectric barrier discharge, and supporting means for positioning the printed matter in such a way that the dye thereon is able to be exposed to the oxidative gas.

8. The achromatization device according to claim 7, wherein the supporting means further includes means for transferring the printed matter into or out of the oxidative-gas applied region in which the oxidative gas generated by the remote plasma device is applied to the printed matter.

9. A method for recycling a recording medium, comprising a step for achromatizing a colored portion on a printed matter by the method for achromatizing a dye according to claim 1.
